(19) United States
(12) Patent Application Publication
(10) Pub. No.: US 2010/0269977 A1
(43) Pub. Date: Oct. 28, 2010

(54) FLEXIBLE JOINT

(76) Inventor: Philip James Mason, Waterlooville (GB)

Correspondence Address: KENYON & KENYON LLP, ONE BROADWAY, NEW YORK, NY, 10004, US

(21) Appl. No.: 12/303,553

(22) PCT Filed: Jul. 30, 2008
(86) PCT No.: PCT/GB2008/050642

§ 371 Date: Jun. 14, 2010

(30) Foreign Application Priority Data
Jul. 31, 2007 (GB) 0714894.3

(51) Int. Cl. B32B 37/00

(52) U.S. Cl. 156/160; 156/443

(57) ABSTRACT

A flexible joint, specifically a flexible joint for radio frequency or DC links between microwave products. A method for connecting two substrates including the steps of: i) bonding an end of a tape to a first substrate, wherein there is a gap formed between the two substrates and the tape is bonded facing away from the gap; ii) bending the tape towards the gap such that the tape is curved back on itself; and iii) bonding the other end of the tape to a second substrate.

### RELATED APPLICATION INFORMATION

This application is a United States National Phase Patent Application of International Patent Application No. PCT/GB2008/050642 which was filed on Jul. 30, 2008, and claims priority to British Patent Application No. 0714894.3, filed on Jul. 31, 2007, the disclosures of each of which are incorporated herein by reference.

### FIELD OF THE INVENTION

The present invention relates to a flexible joint. Specifically, the present invention relates to a flexible joint for radio frequency or DC links between microwave products.

### BACKGROUND INFORMATION

Interlinking tapes are used on a multitude of microwave products. For example, they are used to provide a radio frequency link or DC links between launch pins and substrates. Another example is their use as radio frequency interconnects from substrate to substrate.

### SUMMARY OF THE INVENTION

The present invention relates to a flexible joint. Specifically, the present invention relates to a flexible joint for radio frequency or DC links between microwave products. The present invention also provides a method for connecting two substrates including the steps of: i) bonding an end of a tape to a first substrate, wherein there is a gap formed between the two substrates and the tape is bonded facing away from the gap; ii) bending the tape towards the gap such that the tape is curved back on itself; and iii) bonding the other end of the tape to a second substrate.

### BRIEF DESCRIPTION OF THE DRAWINGS

FIG. 1 is a diagram of a known loop interconnect between two substrates.

FIG. 2 is a diagram of the distortions at different temperatures on a known loop interconnect between two substrates.

FIG. 3 is a diagram of an interconnect according to an embodiment of the present invention.

FIG. 4 is a side view of an interconnect according to an embodiment of the present invention.

FIG. 5 is a side view of an interconnect according to an embodiment of the present invention during the first step of manufacture.

FIG. 6 is a side view of an interconnect according to an embodiment of the present invention during the second step of manufacture.

### DETAILED DESCRIPTION

Exemplary embodiments of the present invention will now be described in more detail, by way of example only, with reference to the accompanying drawings.

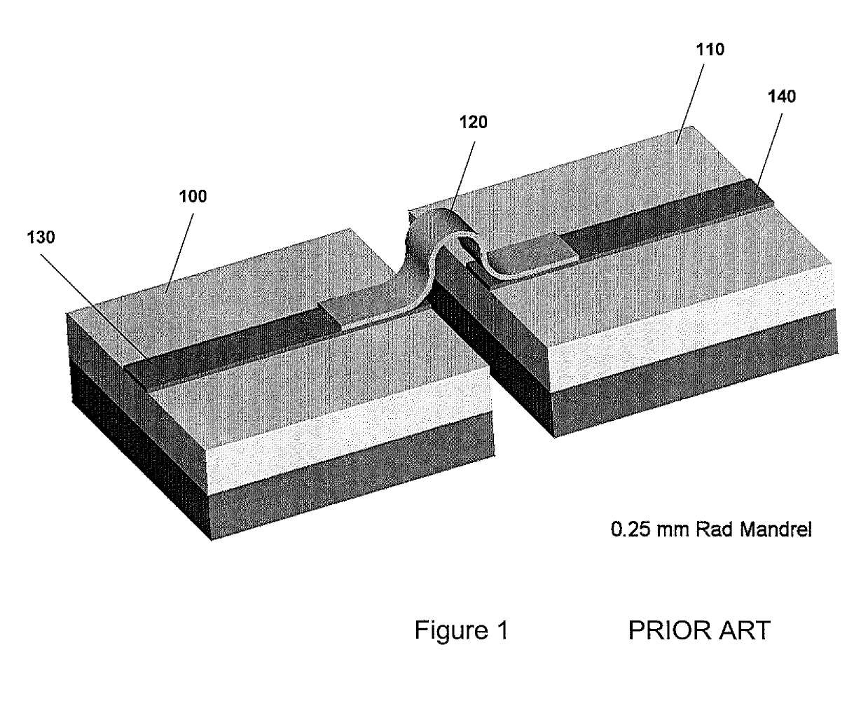

Referring to FIG. 1, there is shown an interconnect 120 between two substrates 100,110. By convention, this is a horse shoe shaped loop 120 connecting the radio frequency tracks 130, 140 on the substrates 100, 110.

The method/process used to produce these loops 120 employs a 0.25 mm mandrel that is fixed to a ceramic tile. A length of the gold ribbon is placed across the mandrel on the tile, then using cocktail sticks it is fashioned to the shape of the mandrel. Once an adequate shape is produce it is then bonded across the two substrates using a parallel gap welder.

The interconnected substrates are made from alumina and attached to gold plated metal matrix carriers. These are subsequently mounted into a machined aluminum box. The thermal coefficient of expansion of alumina is approximately 8.2×10−6 per ° C. and the carrier is roughly matched to this. The thermal coefficient of expansion, however, of the aluminum box is approximately 23×10−6 per ° C.

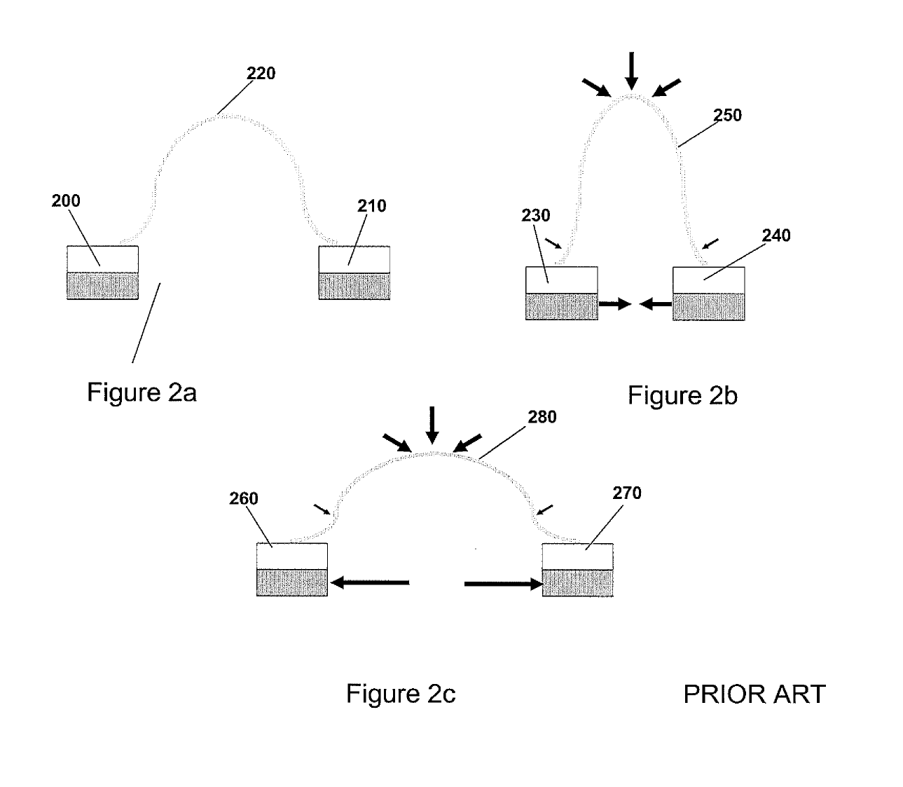

Due to the mismatch of coefficients, the gap between the two substrates will vary as the product under goes thermal change. Under ambient temperature, the interconnect 220 remains at the shape it was originally formed, as shown in FIG. 2a, because the two substrates 200, 210 are unmoved from their positions at which the interconnect 220 was attached. If the apparatus is at a lower temperature than this ambient temperature, the substrates 230, 240 may move towards each other as shown in FIG. 2b, causing the interconnect 250 to change shape. When the apparatus heats up, and is at a higher temperature than the ambient temperature, the substrates 260, 270 will move apart and the interconnect 280 will change shape to adapt again, as shown in FIG. 2b. These changes will occur both in environmental stress screening and during the life of the product. The movement between the two substrates induces stresses into the Gold interlinking tape 220, 250, 280.

The stressing of the joint will cause fatigue of the gold tape 120 despite its ductility and it will deteriorate progressively until it fractures. This is a common problem with this type of interconnect and produces an unacceptable failure rate.

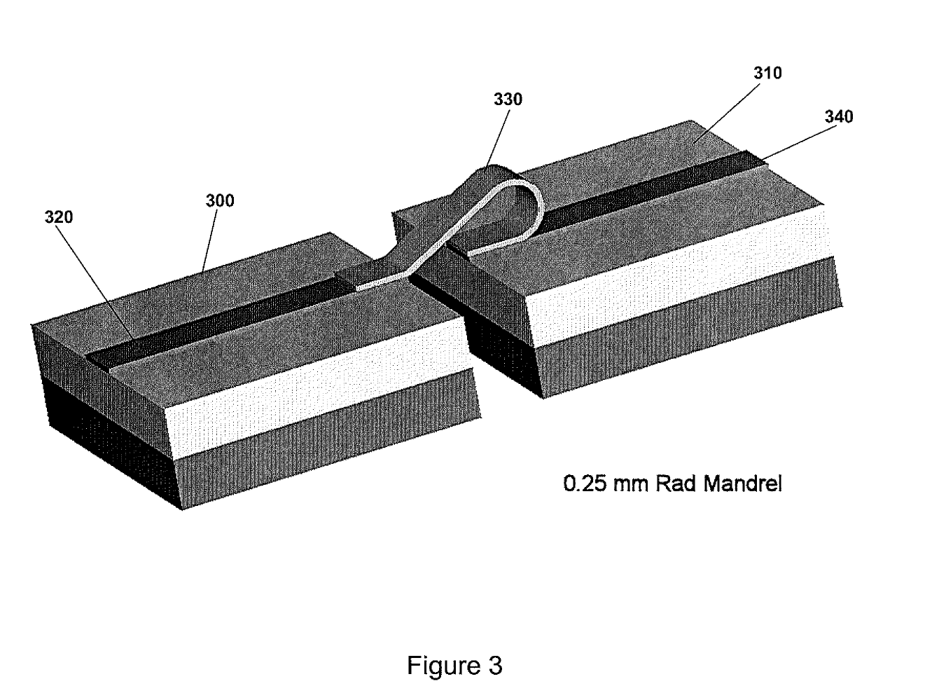

An exemplary embodiment of the present invention will now be described with reference to FIGS. 3 to 6.

Referring to FIG. 3, there is shown an exemplary embodiment of the present invention which will now be described:

The two substrates 300, 310 are linked by a interconnect tape 330, which connects the tracks 320, 340 on the substrates 300, 310. The interconnect tape 330 used is 99.99% pure gold ribbon. The tracks 320, 340 are about 20 μm wide so the interconnect tape 330 used is about 20 μm wide by ½ μm in thickness, with a breaking load of about 150-200 g and elongation of 0.5-3%.

By changing the dominant type of stress within the joint, the amount of force seen by the bond can be reduced. Thus, the effect of the movement can be decreased and so the possibility of fracture.

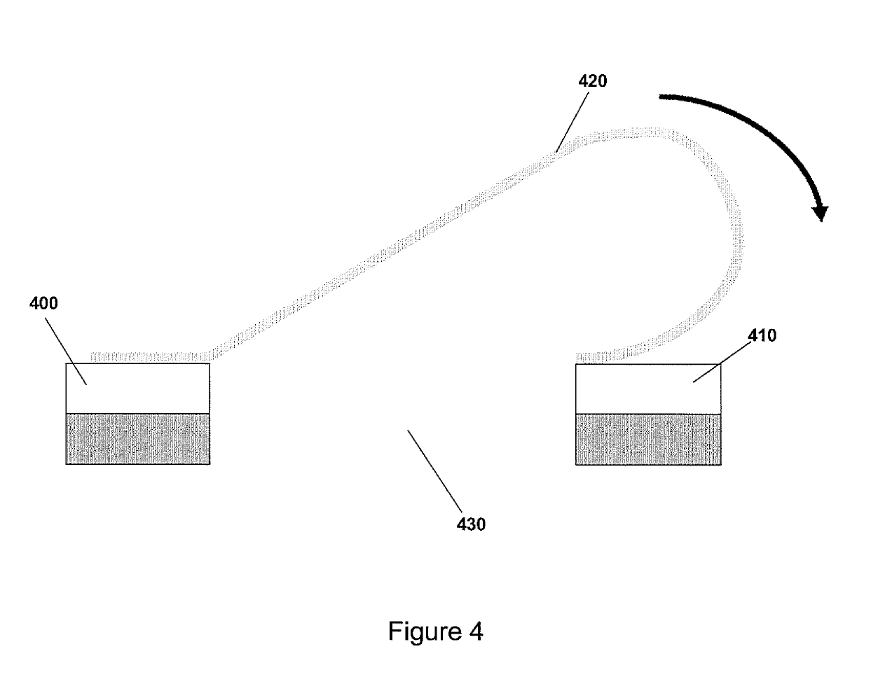

Accordingly, the joint is formed so that it forces a low stress rolling action in the joint material, rather than a high stress bending as in the known horse shoe shaped loop discussed above. When coupled with a very large heel angle, this will improve joint robustness. As seen in FIG. 4, the interconnect tape 420 folds back upon itself in the shape of a hook bridging the gap 430. The interconnect tape 420 has low heel angle and optimum radius so that the joint is forced to roll instead of flex.

It is worth noting that it is not just the lateral movement alone that causes the fatigue. When a material expands and contracts, every linear dimension increases by the same percentage with a change in temperature, including holes, assuming that the expanding material is uniform. Although the linear movement is predominant because of the longer length, there is also some lateral movement between substrates. Compliance and durability in the lateral planes that are not illustrated are also improved by this design.

Referring now to FIGS. 4 to 6, an exemplary embodiment of the method to produce this bond will be described:

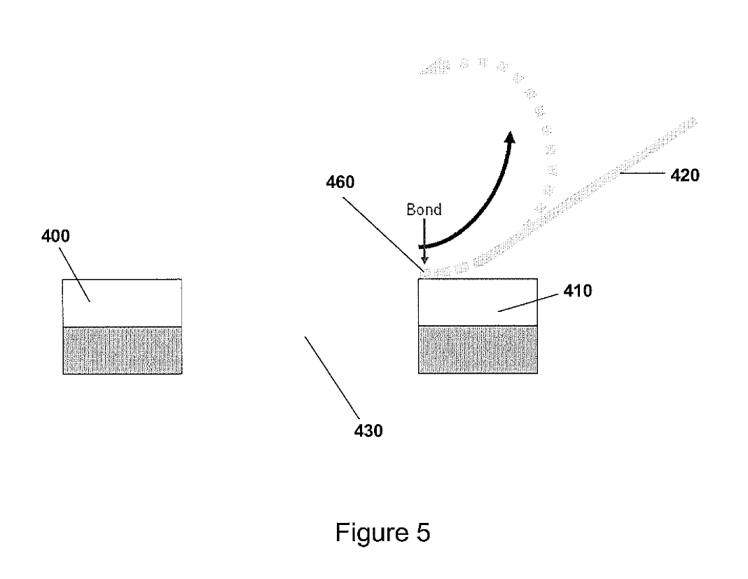

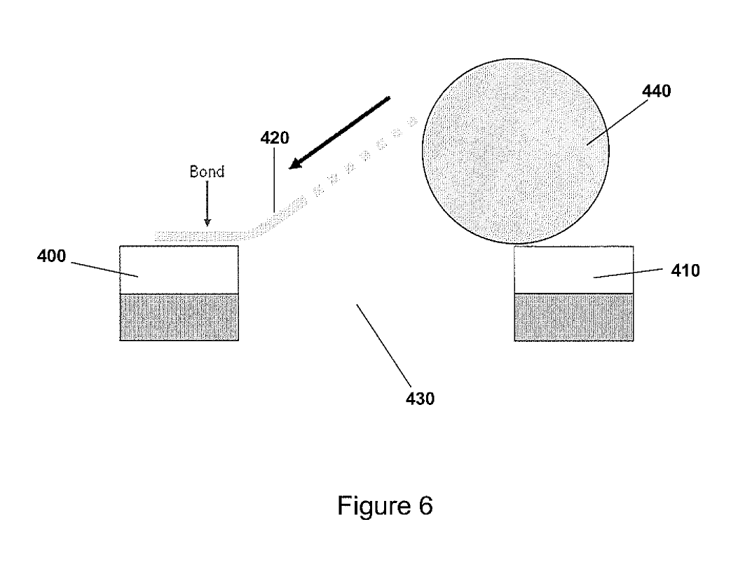

Referring to FIG. 5, the method for producing the joint firstly involves bonding 460 one end of a length of interconnect tape 420 onto one of the tracks 410, so it is running away from the gap 430. Then, as shown in FIG. 6, the interconnect tape 420 is rolled back on itself to form bridge across the gap 430 using a mandrel 440. The radius of the interconnect tape 420 thus formed must not be too great as to prejudice the rolling action of the joint. The second bond 450, to the other track 400 can then be made on the opposite end of the interconnect tape 420, resulting in the joint shown in FIG. 4

It is to be noted that the formation of the looped interconnect tape 420 could be done by eye or a mandrel 440 could be used as a former, as in the previous method of bonding described in relation to the prior art.

It will also be noted that this method could be achieved a number of ways depending one which one is the easiest and the most consistent and that the method described above is an exemplary embodiment of the apparatus and method of the present invention.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1-11. (canceled)

12. A method for connecting two substrates comprising:
i) bonding an end of a tape to a first substrate, wherein there is a gap formed between the two substrates and the tape is bonded facing away from the gap;
ii) bending the tape towards the gap such that the tape is curved back on itself; and
iii) bonding the other end of the tape to a second substrate.

13. The method according to claim 12, wherein the tape is bonded to a radio frequency track on each substrate.

14. The method according to claim 13, wherein the bending (ii) is performed using a mandrel.

15. The method according to claim 14, wherein the tape is bonded to a DC track on each substrate.

16. The method according to claim 12, wherein the bending (ii) is performed using a mandrel.

17. The method according to claim 16, wherein the tape is bonded to a DC track on each substrate.

18. The method according to claim 12, wherein the tape is bonded to a DC track on each substrate.

19. The method according to claim 13, wherein the tape is bonded to a DC track on each substrate.

20. A method for connecting a launch pin to a substrate, the method comprising:
i) bonding an end of a tape to a substrate, wherein there is a gap formed between the substrate and the pin and the tape is bonded facing away from the gap;
ii) bending the tape towards the gap such that the tape is curved back on itself; and
iii) bonding the other end of the tape to a pin.

21. The method according to claim 20, wherein the tape is bonded to a radio frequency track on each substrate.

22. The method according to claim 21, wherein the bending (ii) is performed using a mandrel.

23. The method according to claim 22, wherein the tape is bonded to a DC track on each substrate.

24. The method according to claim 20, wherein the bending (ii) is performed using a mandrel.

25. The method according to claim 24, wherein the tape is bonded to a DC track on each substrate.

26. The method according to claim 20, wherein the tape is bonded to a DC track on each substrate.

27. The method according to claim 21, wherein the tape is bonded to a DC track on each substrate.

28. An apparatus for connecting two substrates, comprising:
a bonding arrangement to bond an end of a tape to a first substrate, wherein there is a gap formed between the two substrates and the tape is bonded facing away from the gap;
a bending arrangement to bend the tape towards the gap such that the tape is curved back on itself; and
another bonding arrangement to bond the other end of the tape to a second substrate.

29. The apparatus according to claim 28, wherein the bending arrangement to bend the tape towards the gap includes a mandrel.

30. The apparatus according to claim 29, wherein the tape is bonded to a DC track on each substrate.

31. An apparatus for connecting a launch pin to a substrate comprising:
a bonding arrangement to bond an end of a tape to a substrate, wherein there is a gap formed between the substrate and the pin and the tape is bonded facing away from the gap;
a bending arrangement to bend the tape towards the gap such that the tape is curved back on itself; and
another bonding arrangement to bond the other end of the tape to a pin.

32. The apparatus according to claim 31, wherein the tape is bonded to a radio frequency track on each substrate.

33. The apparatus according to claim 31, wherein the bending arrangement to bend the tape towards the gap includes a mandrel.

34. The apparatus according to claim 31, wherein the tape is bonded to a DC track on each substrate.
